(19) United States
(12) Patent Application Publication
(10) Pub. No.: US 2010/0159235 A1
(43) Pub. Date: Jun. 24, 2010

(54) Wear component with a carburized case

(76) Inventors: Scott Alan Johnston, East Peoria, IL (US); Gary Donald Keil, Chillicothe, IL (US); Pingshun Zhao, Peoria, IL (US); Robert Lee Meyer, Germantown Hills, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/314,905

(22) Filed: Dec. 18, 2008

(51) Int. Cl. B32B 5/00; C23C 8/20; C23C 8/22

(52) U.S. Cl. 428/332; 148/316; 148/319

(57) ABSTRACT

A wear component includes a base metal and a carburized case on the base metal. The carburized case may have a first region having greater than or equal to about 75% volume fraction of carbides and a second region having greater than or equal to about 20% volume fraction of carbides. The first region may be a region extending to a depth greater than or equal to about 5 microns from a surface of the wear component, and the second region may be a region below the first region and having a thickness greater than or equal to about 100 microns.

### TECHNICAL FIELD

The present disclosure relates generally to a wear component, and more particularly, to a wear component with a carburized case.

### BACKGROUND

The durability of a component that is subject to wear is dependent on the wear resistance of the component. Components such as ground engaging tools (GET), undercarriage components of equipment, cutter rings of tunnel boring machines (TBM), rock drills, etc. are subject to especially severe abrasive wear due to the uncontrolled and unlubricated environments that these components are operated in. Industry has for years experienced the challenge of designing these components that are subject to severe abrasive wear, to have a high abrasion resistance, long wear life and impact resistance. As a wear component, such as, for example a GET, penetrates soil and/or rocks, it begins to wear at locations where the normal forces acting upon the component and the resultant stresses are the highest. With the passage of time, the surfaces of the GET become abraded in a non-uniform manner, and the geometrical relationship of the various surfaces with respect to one another (shape) is altered. This alteration in shape of the GET detrimentally affects its performance.

In the past, increased wear resistance and impact strength of wear components have been achieved by selecting materials that have high hardness and fracture toughness to fabricate the components. This has resulted in wear components fabricated using various tool steels. While the use of some tool steels may improve the wear resistance of these components, it may increase the cost of these components. Therefore, there is a need to develop a wear component having desired wear properties at a lower cost. A technique that has been used in the art to improve the wear resistance of components subjected to less severe wear conditions is carburization. Carburizing is the process of addition of carbon to the surface of low-carbon steels to increase the surface hardness of a steel component. To carburize a steel component, the component is exposed to an atmosphere of carbon at a temperature higher than the austenite transformation temperature of steel. At temperatures higher that the austenite transformation temperature, carbon diffuses readily into the microstructure of steel. The component is maintained at this high temperature for a sufficient time to diffuse a desired amount of carbon to a desired depth of the component. Hardening is accomplished when the high-carbon surface layer is quenched to form martensite. The carburized component will have a high-carbon martensitic case with good wear and fatigue resistance, superimposed on a tough, low-carbon steel core.

Carburizing has been proven to be an effective method of increasing the surface hardness and wear resistance of low carbon steel components. Being a diffusion process, carburizing is affected by the amount of alloying elements in the steel composition and the carburizing process parameters such as the carbon potential of the carburizing gas, the carburizing temperature, and the carburizing time. Typical carburizing seeks to create a hardened case of martensite with some amount of retained austenite. When prolonged carburizing times are used for deep case depths, a high carbon potential produces a high surface-carbon content, which may result in excessive retained austenite or free carbides. It is normally considered unfavorable to form carbides during carburizing because these carbides are thought to adversely affect residual stress distribution and produce sub-surface cracks in the case-hardened part. Therefore, in most common carburizing applications, a steel alloy with carbon content of about 0.2% is chosen as the base material. The carburizing process conditions are also controlled to maintain the carbon content in the carburized layer between 0.8 and 1% C. In some applications, such as rolling and sliding applications, carbides are deliberately created to help refine grain size, reduce friction, or improve pitting and scoring performance. In these cases, a great deal of care is usually taken to control the carbide morphology and avoid high aspect ratio grain-boundary carbides that may drastically reduce performance. The depth of the carbide layer in these applications is typically maintained at a small fraction of the total carburized depth.

U.S. Pat. No. 7,169,238 issued to the assignee of the current disclosure discloses a carburized low carbon steel component with an intentionally produced carbide surface layer for improved pitting, scuffing, and fatigue characteristics on components subjected to metal to metal contact (such, as for example, gears and bearings). In the component of the '238 patent, the volume fraction of carbides is maintained at or above about 20%. While the carburized steel component of the '238 patent has proven to be effective for power train components such as gear teeth and bearings that are subjected to lubricated friction, it may not be as effective for components that are subjected to high load, unlubricated, severe abrasive wear conditions, such as those endured by off highway vehicle undercarriages or GETs.

The disclosed wear component is directed at overcoming the shortcomings discussed above and/or other shortcomings in existing technology.

### SUMMARY OF THE INVENTION

In one aspect, a wear component is disclosed. The wear component includes a base metal and a carburized case on the base metal. The carburized case may have a first region having greater than or equal to about 75% volume fraction of carbides and a second region having greater than or equal to about 20% volume fraction of carbides. The first region may be a region extending to a depth greater than or equal to about 5 microns from a surface of the wear component, and the second region may be a region below the first region and having a thickness greater than or equal to about 100 microns.

In another aspect, an alloy steel component is disclosed. The component may have a carbon content between about 0.36 to about 0.5 percent by weight, and a carburized case. The carburized case may include a first region having a depth greater than or equal to about 5 microns below a surface of the component, and greater than or equal to about 75% volume fraction of carbides.

In yet another aspect, a wear component is disclosed. The wear component may have a carbon content between about 0.36 to about 0.5 percent by weight, and a surface that is configured to be subjected to unlubricated wear. The wear component may also include a case having a region with thickness greater than or equal to about 100 microns and having greater than or equal to about 20% volume fraction of carbides, a large proportion of the carbides being substantially non-spheroidal carbides.

### BRIEF DESCRIPTION OF THE DRAWINGS

FIG. 1 is an illustration of a tunnel boring machine (TBM);

FIG. 2 is an exemplary illustration of a cutter ring of the TBM of FIG. 1;

FIG. 3 is a cross sectional optical micrograph of the cutter ring of FIG. 2;

FIG. 4A is a graphical illustration of an exemplary carburizing step used to form the carburized case of FIG. 3;

FIG. 4B is a graphical illustration of an exemplary hardening step used to form the carburized case of FIG. 3; and

FIG. 5 is a graphical illustration of another exemplary carburizing and hardening step used to form the carburized case of FIG. 3.

### DETAILED DESCRIPTION

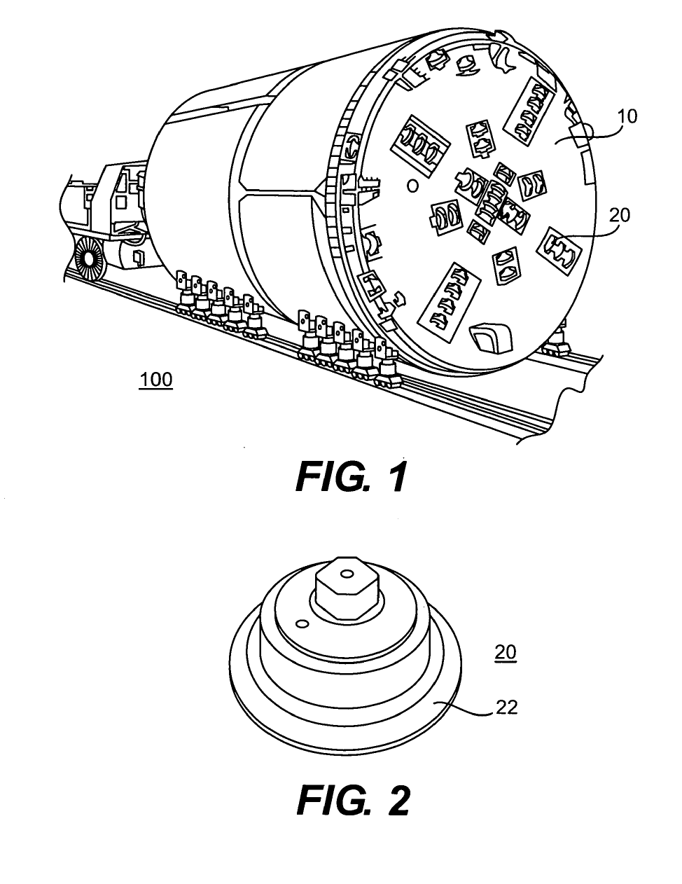

FIG. 1 illustrates an exemplary tunnel boring machine (TBM) 100. TMB 100 may be used to excavate tunnels through a variety of rock strata. TBM 100 may consist of one or more shields 10 (large metal cylinders) and trailing support mechanisms. Attached to shield 10 are rotating cutter rings 20 that may grind against rock. Support mechanisms of TBM 100 may be located behind shield 10, in the excavated part of the tunnel. These support mechanisms may include hydraulic jacks which push TBM 100 forward, conveyor belts or other mechanisms to remove dirt and debris, slurry pipelines, control rooms, etc. Cutter rings 20 typically rotate at 1 to 10 rpm to cut the rock face into chips or debris (muck). This muck is removed using debris removal mechanisms of TBM 100.

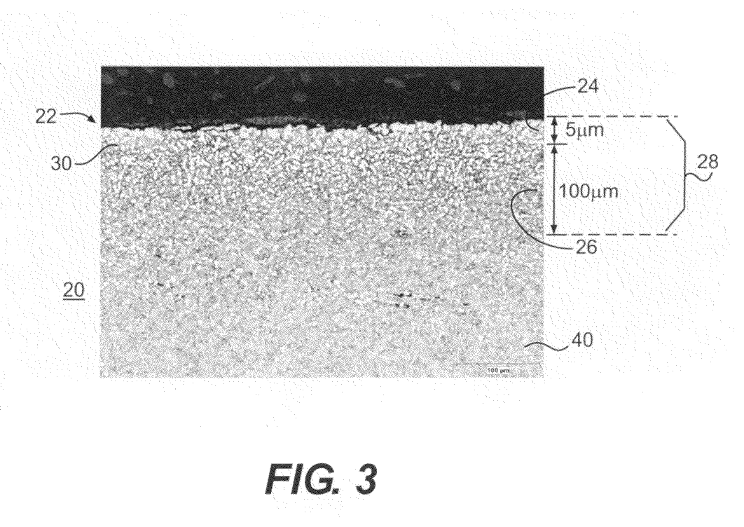

FIG. 2 shows an exemplary cutter ring 20 of TBM 100. During operation of TBM 100, cutter ring 20 may experience severe abrasive wear conditions. Severe abrasive wear conditions refer to wear conditions experienced by a component operating in a highly loaded, unlubricated environment. In such an operating environment, the component may be subjected to uncontrolled wear, such as when abrasive rock particles dislodge from the rock face being cut by cutter ring 20 and abrade (or gouge) an external surface 22 of cutter ring 20. This severe abrasive wear may reduce the effectiveness of cutter ring 20 and may necessitate frequent refurbishment/replacement of cutter ring 20. Frequent replacement of the cutter ring 20 may, in turn, lead to increased operating cost and other operating inefficiencies. To improve the durability, cutter ring 20 (or a portion of cutter ring 20) may be carburized and heat treated to form a case 28 (shown in FIG. 3). Case 28 may have a large volume fraction of carbides. A large proportion of the carbides on case 28 may be substantially non-spheroidal (non-spherical) carbides. The proportion of carbides on cutter ring 20 may be the highest in a region of case 28 adjacent to surface 22, and this proportion may decrease with increasing depth from surface 22. Although cutter ring 20 of TBM 100 is used to illustrate a wear component with a carburized case of the current disclosure, in general, the carburized wear component may be any component that may benefit from increased wear resistance. Practically, components subjected to severe abrasive wear conditions may benefit most from the carburized case of the current disclosure.

FIG. 3 is a cross-sectional optical micrograph with a 3% nital etch of cutter ring 20 with a case 28 formed proximate surface 22. As can be seen in FIG. 3, carburizing cutter ring 20 introduces carbides 30 into the base metal 40 of cutter ring 20. These carbides 30 may be dispersed in the microstructure of the base metal 40 through a depth of a few millimeters from surface 22 of cutter ring 20. In general, the concentration of carbides 30 may decrease with increasing depth from surface 22. In some embodiments, the volume fraction of carbides 30 in a first region 24, which is a region of case 28 extending from surface 22 to a depth of at least about 5 microns from surface 22, may be greater than or equal to about 75%. In some embodiments, the volume fraction of carbides 30 in a second region 26, which is a region of case 28 below first region 24 extending from the bottom of first region 24 and having a thickness of about 100 microns (approx. 4 mm), may be greater than or equal to about 20%. First region 24 and second region 26 may comprise the carburized case 28 of cutter ring 20. Although the thickness of first region 24 and second region 26 are illustrated as being 5 microns and 100 microns respectively, in general, the thicknesses of these regions may be selected based on the application. For instance, for some applications, carburizing conditions may be controlled to form a case 28 having a first region of 10 microns and a second region of about 150 microns.

Base metal 40 may include any carburizing grade material. In some embodiments, base metal 40 may include an alloy steel having a composition, by weight, as listed in Table 1.

TABLE 1
Composition of base metal in weight percent.

| Constituents | Concentration by weight (%) |
|---|---|
| Carbon | 0.3-0.5 |
| Manganese | 0.25-1.7 |
| Molybdenum | 0.2-5.0 |
| Chromium | 0.5-7.0 |
| Copper | 0.0-0.15 |
| Nickel | 0.0-0.10 |
| Carbide forming elements | 1.0-10.0 |
| Hardenability agents | 0.0-11.0 |
| Grain refining elements | 0.0-1.0 |
| Silicon | 0.0-1.0 |
| Iron and other residual elements | Balance |

In some embodiments, the amount of carbon in base metal 40 may be between about 0.36-0.5% by weight. The base metal 40 may be formed to a desired shape of cutter ring 20 by any manufacturing process, such as machining, casting, forging, etc., or combination of processes known in the art. Since these manufacturing processes are well known in the art, they are not discussed herein.

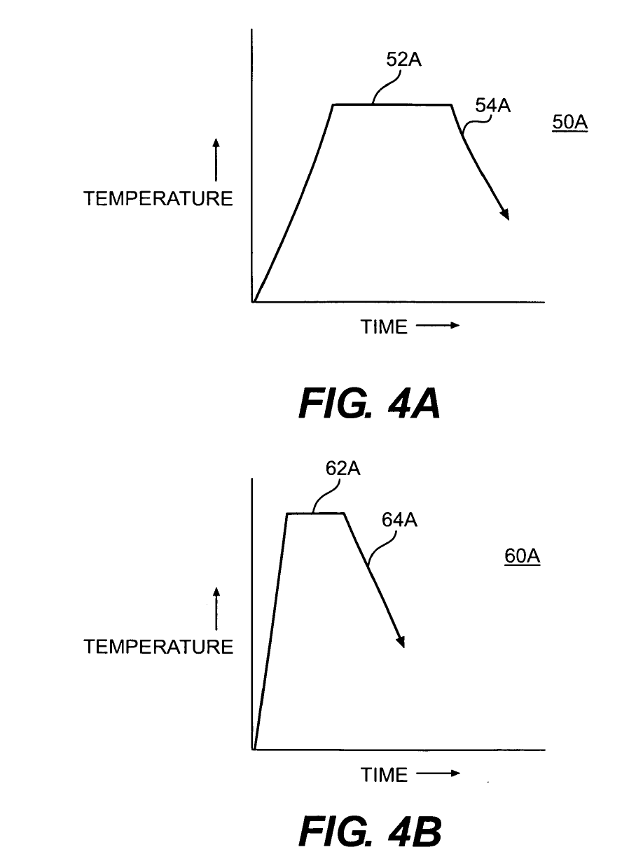

After forming base metal 40 to a desired shape of cutter ring 20, cutter ring 20 may be subjected to one or more carburizing and heat treatment steps to form case 28 on cutter ring 20. FIG. 4A illustrates a carburizing cycle 50A of an embodiment of a carburizing step. In some embodiments, cutter ring 20 may be immersed in a carbon-bearing atmosphere and subjected to one or more cycles of carburizing cycle 50A. The carbon-bearing atmosphere may be continuously replenished to maintain a sufficiently high carbon potential in the atmosphere. Since carburizing processes are well known in the art, only those details of the carburizing process that are relevant to the current disclosure are discussed herein. The carburizing process may be controlled to produce a volume fraction of carbides≧(greater than or equal to) about 75% in first region 24, and ≧20% in second region 26. The carbides 30 formed may be of a variety of shapes and sizes dispersed throughout the microstructure.

Carburizing cycle 50A may include heating cutter ring 20 up to the carburizing segment 52A. According to one embodiment of the disclosure, carburizing segment 52A may include a temperature range between about 850° C. (1562° F.) to 1150° C. (2100° F.), and a carbon bearing atmosphere range approximately equal to or greater than the solubility of carbon in iron for the carburizing temperature. Cutter ring 20 may be held in carburizing segment 52A for a predetermined time based on a desired case depth and total number of carburizing cycles. After holding cutter ring 20 in carburizing segment 52A for the predetermined time, cutter ring 20 may be cooled in cooling segment 54A. In general, the rate of cooling in cooling segment 54A may depend upon the desired amount and distribution of carbides 30 in cutter ring 20. In practice, the cooling rate in cooling segment 54A may also be limited depending upon the type of equipment being used. The rate of cooling in cooling segment 54A may typically vary from about 2° C./min to about 200° C./minute. As mentioned above, in some embodiments, cutter ring 20 may be subjected to multiple cycles of carburizing cycle 50A. Repeated application of carburizing cycle 50A on cutter ring 20 may cause the distribution and morphology of carbides 30 to change.

After carburization, cutter ring 20 may be subject to a hardening cycle 60A. FIG. 4B illustrates an exemplary hardening cycle 60A that may be applied to cutter ring 20. Hardening cycle 60A may redistribute the carbides 30 in the matrix of the base metal 40 and create a hardened case 28. Hardening cycle 60A may include heating cutter ring 20 to a hardening segment 62A. Hardening segment 62A may include a temperature range between the austenitic transformation temperature and the melting temperature of base metal 40. In some embodiments, hardening segment 62A may also include heating cutter ring 20 in a desired ambient. For instance, in some embodiments, hardening segment 62A may include heating cutter ring 20 to a desired temperature in an ambient that may reduce carbon loss from surface 22 of cutter ring 20. The amount of time cutter ring 20 is held at hardening segment 62A (soak time) may depend upon the size of cutter ring 20. In some embodiments, soak time may be increased by about 15 to 90 minutes for every 25 mm of thickness of cutter ring 20. After hardening segment 62A, cutter ring 20 may be quenched in quenching segment 64A. The cooling rate and conditions of quenching segment 64A may depend on the desired thickness and morphology of case 28. In some embodiments, quenching segment 64A may include multiple steps. For instance, in some embodiments, quenching segment 64A may include cooling cutter ring 20 at a first rate to a first temperature (such as, to a temperature above the martensetic temperature), maintaining the first temperature for a predetermined time (so as to form a desired microstructure), and then cooling cutter ring 20 to a lower second temperature at a second cooling rate.

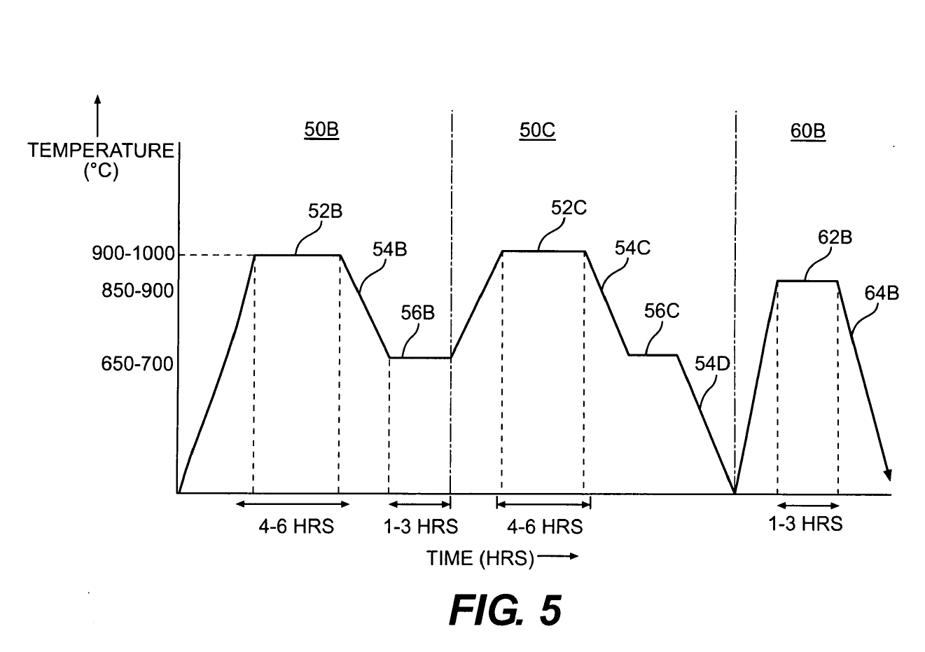

FIG. 5 illustrates another embodiment of the carburizing and heating steps that may be used to form case 28 on cutter ring 20. The carburizing step of the embodiment of FIG. 5 may include a first carburizing cycle 50B and a second carburizing cycle 50C. First carburizing cycle 50B and second carburizing cycle 50C may include heating cutter ring 20 to a carburizing segment (52B, 52C) at a temperature between about 900° C. and 1000° C., and soaking the cutter ring 20 at that temperature in a carbon-bearing atmosphere of an endothermic gas with methane, for about 4-6 hours. After first carburizing segment 52B and second carburizing segment 52C, cutter ring 20 may be cooled to a temperature between about 650° C.-700° C. at a rate of about 2° C./min to 4° C./min, in a furnace under a carbon-bearing atmosphere, in cooling segments 54B and 54C, respectively. Post cooling segment 54B and 54C, cutter ring 20 may be subjected to an isothermal hold 56B, 56C at a temperature between about 650° C.-700° C. for a time period between about 1-3 hours. Isothermal hold 56B, 56C may reduce loss of carbon from surface 22 of cutter ring 20. Post isothermal hold 56C, cutter ring 20 may be cooled to a lower temperature in gas cool step 54D. During gas cool step 54D, cutter ring 20 may be cooled at a cooling rate faster than the cooling rate at cooling segment 54C.

After gas cool step 54D, hardening cycle 60B may be performed by reheating cutter ring 20 to a hardening segment 62B at a temperature between about 845° C. and 900° C. Cutter ring 20 may be held at this temperature for a time period between about 1-3 hours under a carbon-bearing atmosphere. Cutter ring 20 may then be quenched in quenching segment 64B in oil at a rate sufficient to form a hardened case 28 that includes carbides.

### INDUSTRIAL APPLICABILITY

A wear component with the carburized case of the current disclosure may be beneficial for any component where improved wear resistance is desired. The wear component with the carburized case may be especially beneficial for components that may be subject to severe abrasive wear conditions. These severe abrasive wear conditions may include uncontrolled and unlubricated conditions such as those experienced by GETs, equipment under-carriage components, rock drills, etc. The formation of a deep case, containing a large volume fraction of carbides, proximate the surface of the component may increase the wear resistance of the component. Increased wear resistance may improve the durability of the component.

It will be apparent to those skilled in the art that various modifications and variations can be made to the disclosed wear component with a carburized case. Other embodiments will be apparent to those skilled in the art from consideration of the specification and practice of the disclosed wear component with a carburized case. It is intended that the specification and examples be considered as exemplary only, with a true scope being indicated by the following claims and their equivalents.

What is claimed is:

1. A wear component, comprising:
a base metal; and
a carburized case on the base metal, the carburized case having a first region having greater than or equal to about 75% volume fraction of carbides and a second region having greater than or equal to about 20% volume fraction of carbides, the first region being a region extending to a depth greater than or equal to about 5 microns from a surface of the wear component and the second region being a region below the first region and having a thickness greater than or equal to about 100 microns.

2. The wear component of claim 1, wherein the base metal is a steel having a carbon content between about 0.3 weight percent and about 0.5 weight percent.

3. The wear component of claim 2, wherein the carbon content in the base metal is greater than about 0.36 weight percent.

4. The wear component of claim 2, wherein the base metal includes about 0.25 weight percent to about 1.7 weight percent of manganese and about 0.2 weight percent to about 5 weight percent of molybdenum.

5. The wear component of claim 2, wherein the base metal includes about 0.5 weight percent to about 7 weight percent of chromium and copper less than or equal to about 0.15 weight percent.

6. The wear component of claim 2, wherein the base metal includes about 1 to about 10 weight percent of carbide forming elements.

7. The wear component of claim 1, wherein the wear component is a component configured for operation in severe abrasive wear conditions.

8. The wear component of claim 1, wherein the wear component is a ground engaging tool (GET).

9. The wear component of claim 1, wherein the wear component is a component of a tunnel boring machine cutter head.

10. The wear component of claim 1, wherein the wear component is a component of a rock drill.

11. An alloy steel component, comprising:
a carbon content between about 0.36 to about 0.5 percent by weight; and
a carburized case including a first region having a depth greater than or equal to about 5 microns below a surface of the component, the first region having greater than or equal to about 75% volume fraction of carbides.

12. The component of claim 11, wherein the carburized case further includes a second region below the first region, the second region having greater than or equal to about 20% volume fraction of carbides.

13. The component of claim 12, wherein the second region has a thickness greater than or equal to about 100 microns.

14. The component of claim 11, further including about 0.25 weight percent to about 1.7 weight percent of manganese and about 0.2 weight percent to about 5 weight percent of molybdenum.

15. The component of claim 11, further including about 0.5 weight percent to about 7 weight percent of chromium, copper less than or equal to about 0.15 weight percent, and about 1 to about 10 weight percent of carbide forming elements.

16. The component of claim 11, wherein the component is a part configured for operation in severe abrasive wear conditions.

17. The component of claim 11, wherein the carbides are substantially non-spheroidal carbides.

18. A wear component, comprising:
carbon content between about 0.36 to about 0.5 percent by weight;
a surface that is configured to be subjected to unlubricated wear; and
a case including a region having a thickness greater than or equal to about 100 microns having greater than or equal to about 20% volume fraction of carbides, a large proportion of the carbides being substantially non-spheroidal carbides.

19. The component of claim 18, wherein the case further includes a region having a thickness greater than or equal to about 5 microns and greater than or equal to about 75% volume fraction of carbides.

20. The component of claim 18, further including about 0.25 weight percent to about 1.7 weight percent of manganese, about 0.2 weight percent to about 2 weight percent of molybdenum, about 0.5 weight percent to about 2.5 weight percent of chromium, copper less than or equal to about 0.15 weight percent, and about 1 to about 10 weight percent of carbide forming elements.
